(19) United States
(12) Patent Application Publication
(10) Pub. No.: US 2009/0164528 A1
(43) Pub. Date: Jun. 25, 2009

(54) Information Handling System Personalization

(75) Inventors: Robert Hunter Robertson, Cedar Park, TX (US); Bogdan Odulinski, Austin, TX (US); Jeffrey V. Ford, Cary, NC (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 11/962,408

(22) Filed: Dec. 21, 2007

(51) Int. Cl. G06F 17/00

(52) U.S. Cl. 707/204; 707/E17.005

(57) ABSTRACT

Information handling system (IHS) personalization includes receiving a request for a replacement IHS. A plurality of customer IHS data is then collected. The plurality of customer IHS data is transferred to the replacement IHS during the manufacture of the replacement IHS. The replacement IHS is then provided to a user of the customer IHS data.

### BACKGROUND

The present disclosure relates generally to information handling systems and more particularly to information handling system personalization.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHS technologies can become obsolete over time. For example, an IHS may be the state of the art when purchased and then become underpowered in a relatively short period of time, environmental factors may lead to failure of the IHS or components of the IHS, or the IHS may be stolen. During the life of the IHS, the IHS becomes personalized for the user of the IHS due to unique data such as, for example, user preferences, applications, personal files, and/or digital music and photos, that the user may generate and/or stored on the IHS. The replacement of such IHSs raises a number of issues.

Typically, the replacement of an IHS with such unique data involves several steps of varying complexity that require the customer have access to a combination of trusted human resources and/or tools to help transfer their unique data from the original IHS to the replacement IHS. For example, transfer of the unique data may require the use of storage devices, cables, and/or peer-to-peer network connections in order to connect the original and replacement IHSs together and perform a manual process of transferring files from the original IHS to the replacement IHS. Furthermore, a relatively significant level of knowledge and sophistication may be required to implement the end-to-end processing needed to identify, connect, and transfer the correct data to the correct destination.

Accordingly, it would be desirable to provide improved IHS personalization.

### SUMMARY

According to one embodiment, a method for IHS personalization includes receiving a request for a replacement IHS, collecting a plurality of customer IHS data, transferring the plurality of customer IHS data to the replacement IHS during the manufacture of the replacement IHS, and providing the replacement IHS to a user of the customer IHS data.

### BRIEF DESCRIPTION OF THE DRAWINGS

FIG. 1 is a schematic view illustrating an embodiment of an IHS.

FIG. 2a is a schematic view illustrating an embodiment of an IHS personalization system.

FIG. 2b is a schematic view illustrating an embodiment of a provider used with the IHS personalization system of FIG. 2a.

FIG. 3a is a flow chart illustrating an embodiment of a method for IHS personalization.

FIG. 3b is a schematic view illustrating an embodiment of the transfer of customer IHS data from a customer IHS to a database and to a replacement IHS.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

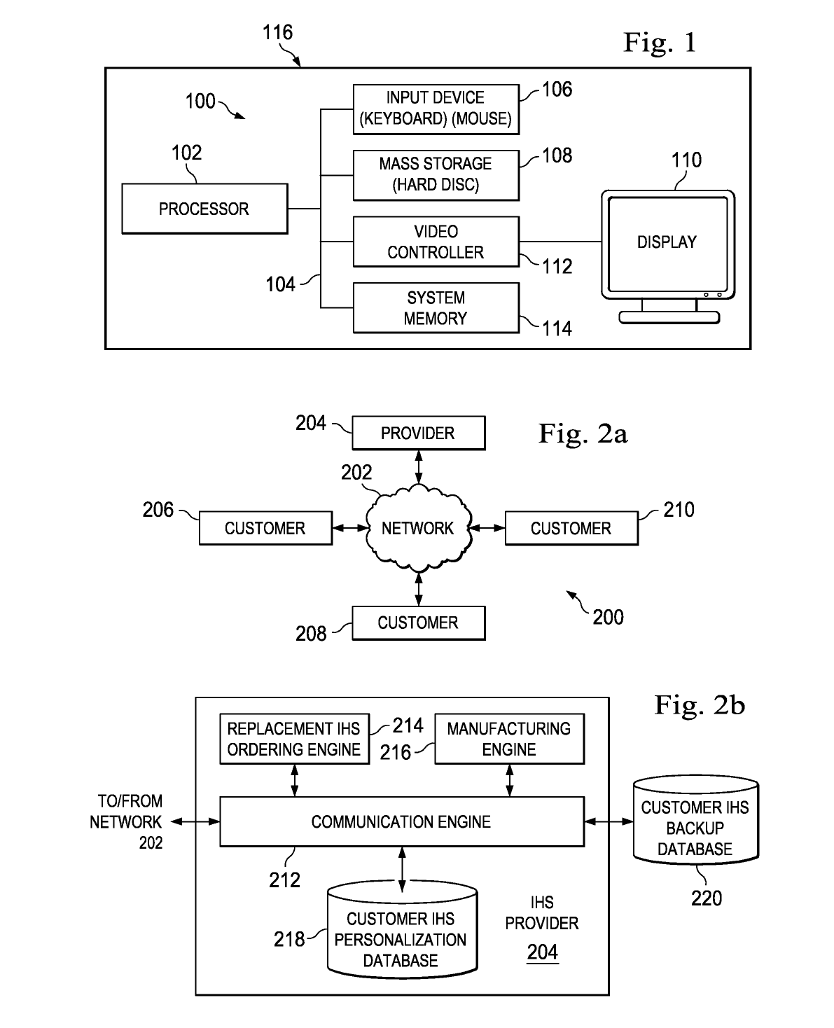

In one embodiment, IHS 100, FIG. 1, includes a processor 102, which is connected to a bus 104. Bus 104 serves as a connection between processor 102 and other components of computer system 100. An input device 106 is coupled to processor 102 to provide input to processor 102. Examples of input devices include keyboards, touchscreens, and pointing devices such as mouses, trackballs and trackpads. Programs and data are stored on a mass storage device 108, which is coupled to processor 102. Mass storage devices include such devices as hard disks, optical disks, magneto-optical drives, floppy drives and the like. IHS 100 further includes a display 110, which is coupled to processor 102 by a video controller 112. A system memory 114 is coupled to processor 102 to provide the processor with fast storage to facilitate execution of computer programs by processor 102. In an embodiment, a chassis 116 houses some or all of the components of IHS 100. It should be understood that other buses and intermediate circuits can be deployed between the components described above and processor 102 to facilitate interconnection between the components and the processor 102.

Referring now to FIG. 2a, an IHS personalization system 200 is illustrated. The IHS personalization system 200 includes a network 202 such as, for example, a Transport Control Protocol/Internet Protocol (TCP/IP) network (e.g., the Internet or an intranet). An IHS provider 204 is operably coupled to the network 202. A plurality of customers 206, 208 and 210 are also operably coupled to the network 202 in order to allow communication between the customers 206, 208 and 210 and the IHS provider 204. In the discussion below, the customer 206 is a representative one of the customers 206, 208 and 210. In an embodiment, the IHS provider 204 may be, for example, a manufacturer of IHSs, a seller of IHSs, a repairer of IHSs, combinations thereof, and/or a variety of other IHS providers known in the art.

Each of the IHS provider 204 and the customers 206, 208 and 210 includes a respective network interface for communicating with the network 202 (e.g., outputting information to, and receiving information from, the network 202), such as by transferring information (e.g., instructions, data, signals) between such customers and the network 202. Accordingly, through the network 202, the IHS provider 204 communicates with the customers 206, 208 and 210, and the customers 206, 208 and 210 communicate with the IHS provider 204. Each of the IHS provider 204 and the customers 206, 208 and 210 may include a respective IHS such as, for example, the IHS 100 described above with reference to FIG. 1. Moreover, as illustrated in FIG. 2a, all such IHSs may be coupled to each other through the network 202.

Referring now to FIG. 2b, the IHS provider 204 is illustrated in more detail. The IHS provider 204 includes a communication engine 212 that is operatively coupled to the network 202, to a replacement IHS ordering engine 214, to a manufacturing engine 216, to a customer IHS personalization database 218 located within the IHS provider 204, and to a customer IHS backup database 220 located outside the IHS provider 204. In an embodiment, the replacement IHS engine 214 may be software located on an IHS of the IHS provider 204 and is operable to receive requests for a replacement IHS from, for example, one of the customers 206, 208 and/or 210. In an embodiment, a request for a replacement IHS may include a request for a new IHS (e.g. when the IHS provider 204 sells a new IHS to the customer 206), a request for refurbished IHS (e.g., when the customer 206 has the IHS provider replace a component such as, for example, a storage component, on their IHS), and/or a variety of other IHS replacement scenarios known in the art. In an embodiment, the manufacturing engine 216 may be software located on an IHS of the IHS provider 204 and is utilized during the manufacture of IHSs to, for example, load data onto the IHS being manufactured. In an embodiment, the customer IHS personalization database 218 and the customer IHS backup database 220 are conventional databases known in the art. While the customer IHS personalization database 218 is illustrated as being located within the IHS provider 204, the customer IHS personalization database 218 may be located outside the IHS provider 204 and coupled to the IHS provider 204 through, for example, the network 202. While the customer IHS backup database 220 is illustrated as being located outside the IHS provider 204, the backup database 220 may be located within the IHS provider 204. While the customer IHS personalization database 218 and the customer IHS backup database 220 are illustrated as being two separate database, they may each include a plurality of databases, or they may be combined into a single database that may be located either within or outside of the IHS provider 204.

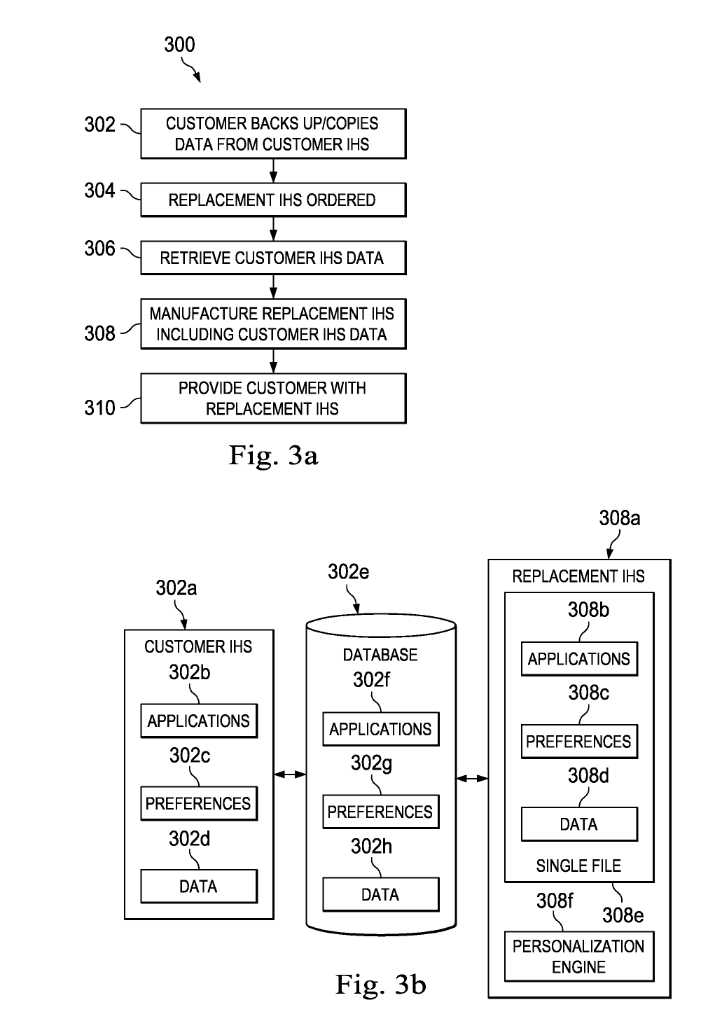

Referring now to FIGS. 2b, 3a and 3b, a method 300 for IHS personalization is illustrated. The method 300 begins at block 302 where the customer 206 backs up/copies data from a customer IHS. In an embodiment, the customer 206 is a user of a customer IHS 302a that includes a plurality of customer IHS data including, for example, applications 302b, preferences 302c, and data 302d, illustrated in FIG. 3b. In an embodiment, the customer IHS 302a may be the IHS 100, described above with reference to FIG. 1. In an embodiment, the applications 302b include programs installed on the customer IHS 302a such as, for example, email programs, instant messaging programs, mapping programs, document creation and editing programs, photo editing programs, internet browser programs, file transfer programs, and/or a variety of other applications or programs known in the art. In an embodiment, the preferences 302c include settings on the customer IHS 302a such as, for example, display settings, power options, internet options, control panel applet settings, and/or a variety of other preferences or settings known in the art. In an embodiment, the data 302d includes files on the customer IHS 302a such as, for example, audio files, video files, document files, and/or a variety of other data or files known in the art. In an embodiment, the applications 302b and/or the preferences 302c may be referred to as IHS personalization data. In an embodiment, the data 302d may be referred to as IHS backup data. A database 302e is illustrated in FIG. 3b and represents both of the customer IHS personalization database 218 and the customer IHS backup database 220, illustrated in FIG. 2b. In an embodiment, the customer 206 may back up/copy the customer IHS data from the customer IHS 302a to the database 302e to create applications 302f on the database 302e which are a copy of the applications 302b on the customer IHS 302a. In an embodiment, the customer 206 may back up/copy the customer IHS data from the customer IHS 302a to the database 302e to create preferences 302g on the database 302e which are a copy of the preferences 302c on the customer IHS 302a. In an embodiment, the customer 206 may back up/copy the customer IHS data from the customer IHS 302a to the database 302e to create data 302h on the database 302e which is a copy of the data 302d on the customer IHS 302a. The customer 206 may back up/copy the customer IHS data from the customer IHS 302a to the database 302e at regular time intervals such as, for example, monthly, weekly, daily, hourly, and so on.

In a particular embodiment, the customer 206 backs up/copies the data 302d in the customer IHS 302a to the customer IHS backup database 220 at regular time intervals. In one example, the customer IHS backup database 220 may be located within the provider 204 and the customer 206 may subscribe to a service of the provider 204 that allows the regular back up/copying of the data 302d on the customer IHS 302a to the customer IHS backup database 220. In that example, the data 302d may be backed up/copied to the customer IHS backup database 220 through the communication engine 212. In another example, the customer IHS backup database 220 may be located outside of the provider 204 and the customer 206 may subscribe to a service of a third party that allows the regular back up/copying of the data 302d on the customer IHS 302a to the customer IHS backup database 220.

In a particular embodiment, the customer 206 backs up/copies the applications 302b and the preferences 302c in the customer IHS 302a to the customer IHS personalization database 218 at regular time intervals. In one example, the customer IHS personalization database 218 may be located within the provider 204 and the customer 206 may subscribe to a service of the provider 204 that allows the regular back up/copying of the applications 302b and the preferences 302c on the customer IHS 302a to the customer IHS personalization database 218. In that example, the applications 302b and the preferences 302c may be transferred to the customer IHS personalization database 218 through the communication engine 212. In another example, the customer IHS personalization database 218 may be located outside of the provider 204 and the customer 206 may subscribe to a service of a third party that allows the regular back up of the applications 302b and the preferences 302c on the customer IHS 302a to the customer IHS personalization database 218.

The method 300 then proceeds to block 304 where a replacement IHS is ordered. In an embodiment, the customer 206 may communicate with the replacement IHS ordering engine 214 through the communication engine 212 to order a replacement IHS 308a, illustrated in FIG. 3b. In another embodiment, a replacement IHS 308a is ordered for the customer 206 by, for example, a third party such as an insurance company that insured the customer IHS 302a. In one example, the customer 206 communicates with the replacement IHS ordering engine 214 to place an order for the purchase of a new IHS to replace the customer IHS 302a. In an embodiment, the new IHS includes an operating system that is different from the operating system that is used on the customer IHS 302a. In another example, the customer 206 communicates with the replacement IHS ordering engine 214 to order a component for the customer IHS 302a such as, for example, the mass storage device 108 described above with reference to the IHS 100 of FIG. 1.

After verification of an ordered replacement IHS by the replacement IHS ordering engine 214, the communication engine 212 determines that the customer 206 would like to personalize the replacement IHS. In an embodiment, the communication engine 212 may determine that the customer 206 backs up/copies some or all of the customer IHS data, as described above, and the communication engine 212 may give the customer 206 the option of personalizing the replacement IHS 308a, described in further detail below. In an embodiment, block 302 of the method 300 may be skipped as the customer 206 may not back up/copy any of the customer IHS data, and the communication engine 212 may determine that block 302 of the method 300 has not been performed and may give the customer 206 the option of personalizing the replacement IHS 308a, described in further detail below.

The method 300 then proceeds to block 306 where the customer IHS data is retrieved. In a particular embodiment, the customer 206 regularly backs up/copies the customer IHS data including backing up/copying IHS personalization data (e.g. the applications 302b and/or the preferences 302c) in the customer IHS 302a to the customer IHS personalization database 218 and backing up/copying the IHS backup data (e.g. the data 302d) in the customer IHS 302a to the customer IHS backup database 220. In an embodiment, some or all of the customer IHS data may be encrypted using methods known in the art to prevent the provider 204 from viewing the customer IHS data.

In a particular embodiment, the customer 206 regularly backs up/copies the IHS backup data (e.g., the data 302d) in the customer IHS 302a to the customer IHS backup database 220, but does not back up/copy the IHS personalization data (e.g. the applications 302b and/or the preferences 302c) on the customer IHS 302a. In that embodiment, the communication engine 212 may send the customer 206 a data migration engine which may be, for example, software or a software package to be run on the customer IHS 302a. The data migration engine may be sent to the customer 206, for example, on a storage disk, as an electronic file, as a link to an electronic file to download, or using a variety of other methods known in the art. The customer 206 may then run the data migration engine on the customer IHS 302a and the data migration engine will collect the IHS personalization data that is located on the customer IHS 302a and that includes, for example, the applications 302b, the preferences 302c, and/or other data in the customer IHS 302a that is personalized to the customer 206. The data migration engine then sends that IHS personalization data through the communication engine 212 to the customer IHS personalization database 218. In an embodiment, the data migration engine may encrypt the IHS personalization data using methods known in the art before sending the IHS personalization data to the customer IHS personalization database 218. In another embodiment, the customer IHS personalization data may be encrypted anytime during the method 300 to prevent the provider 204 from viewing the IHS personalization data.

In a particular embodiment, the customer 206 does not regularly back up/copy the customer IHS data. In that embodiment, the communication engine 212 may send the customer 206 a data migration engine which may be, for example, software to be run on the customer IHS 302a. The data migration engine may be sent to the customer 206, for example, on a storage disk, as an electronic file, a link to an electronic file to download, or using a variety of other methods known in the art. The customer 206 may then run the data migration engine on the customer IHS 302a and the data migration engine will collect the IHS personalization data that is located on the customer IHS 302a and that includes, for example, the applications 302b, the preferences 302c, and/or other data in the customer IHS 302a that is personalized to the customer 206. In an embodiment, the data migration engine may also collect the IHS backup data that is located on the customer IHS 302a and that includes, for example, the data 302d and/or other data or files in the customer IHS 302a. The data migration engine then sends that IHS personalization data through the communication engine 212 to the customer IHS personalization database 218 and/or the IHS backup data through the communication engine 212 to the customer IHS backup database 218. In an embodiment, the data migration engine may encrypt the IHS personalization data and/or the IHS backup data using methods known in the art before sending the IHS personalization data to the customer IHS personalization database 218 and/or the IHS backup data to the customer IHS backup database 220. In another embodiment, the IHS personalization data and/or the IHS backup data may be encrypted anytime during the method 300 to prevent the provider 204 from viewing the IHS personalization data and/or the IHS backup data.

The customer IHS data may then be retrieved by the communication engine 212 by accessing the customer IHS backup database 220 to retrieve the IHS backup data (e.g. the data 302h in the database 302e) and/or by accessing the customer IHS personalization database 218 to retrieve the IHS personalization data (e.g. the applications 302f and/or the preferences 302g). As described above, in an embodiment, the customer 206 may not back up IHS backup data in the customer IHS backup database 220, as described in block 302 of the method 300, and the retrieving of customer IHS data in block 306 of the method 300 may only involve the retrieval of the IHS personalization data from the customer IHS personalization database 218.

The method 300 then proceeds to block 308 where a replacement IHS including the customer IHS data is manufactured. The customer IHS data including the IHS backup data and/or the IHS personalization data is sent by the communication engine 212 to the manufacturing engine 216. The manufacturing engine 216 takes the customer IHS data and copies it onto a replacement IHS 308a that was ordered by the customer 206 in block 304 of the method 300. In an embodiment, the replacement IHS 308a may be, for example, the IHS 100 described above with reference to FIG. 1, and the customer IHS data may be copied on to the mass storage 108 or other storage device on the IHS 100. In an embodiment, the replacement IHS 308a is a replacement component for an IHS such as, for example, a storage device, and the customer IHS data may be copied onto that storage device. In an embodiment, the copying of the customer IHS data onto the replacement IHS occurs at the location of manufacture of the replacement IHS such as, for example, the location where the new IHS is assembled from its component parts. In an embodiment, the manufacturing engine 216 is operable to take the customer IHS data (e.g. the applications 308b, the preferences 308c, and the data 308d) and copy it to the appropriate locations on the replacement IHS 308a. In an embodiment, the appropriate locations for the customer IHS data on the replacement IHS 308a may be different locations than the locations for the customer IHS data on the customer IHS 302a due to, for example, the replacement IHS 308a using a different operating system than the customer IHS 302a.

In an embodiment, the customer IHS data is packaged by the manufacturing engine 216 into a single file 308e that includes a copy of the IHS backup data (the data 308d) and/or the IHS personalization data (e.g. the applications 308b and/or the preferences 308c) and that file 308e is then saved on the replacement IHS 308a. In an embodiment, the manufacturing engine 216 also provides a personalization engine 308f on the replacement IHS 308a. The personalization engine 308f may be, for example, software on the replacement IHS 308a that is operable to unpack the customer IHS data (e.g. from a single file or a plurality of files) and migrate that data onto the appropriate locations on the replacement IHS 308a, as will be described in further detail below.

The method 300 then proceeds to block 310 where the replacement IHS 308a is provided to the customer 206. The provider 204 may provide the replacement IHS 308a to the customer 206 using methods known in the art. In an embodiment, the customer 206 may receive the replacement IHS 308a with the customer IHS data already migrated onto the appropriate locations on the replacement IHS 308a such that the customer 206 can begin using the replacement IHS 308a with all the same data and personalization as the customer IHS 302a. In an embodiment, the migrating data to the appropriate location on the replacement IHS 308a includes putting the data in locations on the replacement IHS 308a such that the data will seem to the customer 206 to be in the same place on the replacement IHS 308a as it was on the customer IHS 302a (e.g. a document that existed in a My Documents Folder on the customer IHS 302a will be in the My Documents Folder on the replacement IHS 308a.) However, such migration may result in the data not being located in the same physical location on the replacement IHS 308a as it was in the customer IHS 302a. In an embodiment, the customer 206 may be supplied with an authentication password for the replacement IHS 308a. Upon the initial powering up the replacement IHS 308a, the customer 206 may be prompted for the authentication password to confirm that the customer 206 has received the correct replacement IHS 308a with the correct customer IHS data. Upon providing the correct authentication password, the personalization engine 308f will operate to migrate the customer IHS data to the replacement IHS 308a. In an embodiment, the encryption of the customer IHS data before it leaves the customer IHS 302a and the use of the authentication password to initiate the migration of the customer IHS data to the replacement IHS 308a provides end-to-end privacy the prevents parties other than the customer 206 from viewing any of the customer IHS data. In an embodiment, the personalization engine 308f unpacks the customer IHS data that was loaded as a single file 308e on the replacement IHS 308a and stores that data in a temporary location on the replacement IHS 308a. The personalization engine 308f then extracts the IHS personalization data from the customer IHS data and copies it to the appropriate locations on the replacement IHS 308a by, for example, setting up user names and passwords, applying desktop themes, applying settings, and/or setting up on the replacement IHS 308a with other personalization data known in the art. The personalization engine 308f then migrates the IHS backup data to the appropriate locations on the replacement IHS 308a. In an embodiment, the migrating data to the appropriate location on the replacement IHS 308a includes putting the data in locations on the replacement IHS 308a such that the data will seem to the customer 206 to be in the same place on the replacement IHS 308a as it was on the customer IHS 302a (e.g. a document that existed in a My Documents Folder on the customer IHS 302a will be in the My Documents Folder on the replacement IHS 308a.) However, such migration may result in the data not being located in the same physical location on the replacement IHS 308a as it was in the customer IHS 302a. In an embodiment, the appropriate locations for the customer IHS data on the replacement IHS 308a may be different locations than the locations for the customer IHS data on the customer 302a due to, for example, the replacement IHS 308a using a different operating system than the customer IHS 302a. The personalization engine 308f then deletes the temporary data stored on the replacement IHS 308a and may back up/copy the customer IHS data (e.g. the applications 302b, the preferences 308c, and/or the data 308d) on the replacement IHS 308a to the database 302e. Thus, a system is provided that allows a customer to personalize a replacement IHS such that the replacement IHS will include some or all of the customer IHS data from the replaced IHS including IHS backup data and IHS personalization data.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A system for personalization of an IHS, comprising:
a replacement IHS ordering engine that is operable to receive an order for a replacement IHS;
a communication engine that is operable to collect a plurality of customer IHS data and store it in a database; and
a manufacturing engine that is operable to transfer the plurality of customer IHS data from the database to the replacement IHS during the manufacture of the replacement IHS.

2. The system of claim 1, wherein the plurality of customer IHS data comprises IHS personalization data.

3. The system of claim 1, wherein the plurality of customer IHS data comprises IHS backup data.

4. The system of claim 1, wherein the customer IHS data is encrypted before the customer IHS data is stored in the database.

5. The system of claim 1, wherein the communication engine is operable provide the replacement IHS to a user of the customer IHS data subsequent to the manufacture of the replacement IHS.

6. The system of claim 1, wherein the manufacturing engine provides a personalization engine on the replacement IHS, and wherein the personalization engine is operable to migrate the customer IHS data to the appropriate locations on the replacement IHS upon the provision of an authentication password.

7. A method for IHS personalization, comprising:
receiving a request for a replacement IHS;
collecting a plurality of customer IHS data;
transferring the plurality of customer IHS data to the replacement IHS during the manufacture of the replacement IHS; and
providing the replacement IHS to a user of the customer IHS data.

8. The method of claim 7, wherein the receiving a request for a replacement IHS comprises receiving an order for the purchase of a new IHS.

9. The method of claim 7, wherein the collecting a plurality of customer IHS data comprises collecting a plurality of IHS personalization data.

10. The method of claim 7, wherein the collecting a plurality of customer IHS data comprises collecting a plurality of IHS backup data.

11. The method of claim 7, wherein the transferring the plurality of customer IHS data to the replacement IHS comprises transferring a personalization engine to the replacement IHS that is operable to migrate the customer IHS data to the appropriate locations on the replacement IHS.

12. The method of claim 7, wherein the plurality of customer IHS data that is collected is encrypted.

13. The method of claim 7, wherein, subsequent to the provision of the replacement IHS to the user of the customer IHS data, the user of the customer IHS data provides an authentication password to the replacement IHS in order to activate a personalization engine on the replacement IHS that migrates the customer IHS data to the appropriate locations on the replacement IHS.

14. The method of claim 7, further comprising:
providing a customer IHS backup database, wherein the plurality of customer IHS data comprises a plurality of IHS backup data that has been transferred from a customer IHS to the customer IHS backup database.

15. The method of claim 7, further comprising:
providing a customer IHS personalization database; and
providing the user of the customer IHS data a data migration engine, wherein the plurality of customer IHS data comprises a plurality of IHS personalization data that has been transferred to the customer IHS personalization database.

16. A method for transferring data to an IHS, comprising:
transferring a plurality of IHS backup data from a customer IHS to a customer IHS backup database;
requesting a replacement IHS;
operating a data migration engine to transfer a plurality of IHS personalization data from the customer IHS to a customer IHS personalization database; and
receiving the replacement IHS comprising the plurality of IHS backup data and the plurality of IHS personalization data.

17. The method of claim 16, wherein the transferring the plurality of IHS backup data from the customer IHS to the customer IHS backup database comprises transferring IHS backup data at regular time intervals.

18. The method of claim 16, wherein the receiving a replacement IHS comprises receiving a replacement IHS including a personalization engine, and wherein the method further comprises:
providing an authentication password to the personalization engine in order to migrate the plurality of IHS backup data and the plurality of IHS personalization data to the appropriate locations on the replacement IHS.

19. The method of claim 16, wherein the requesting a replacement IHS comprises purchasing a new IHS.

20. The method of claim 16, wherein the transferring of the plurality of IHS backup data and the plurality of IHS personalization data comprises encrypting the plurality of IHS backup data and the plurality of IHS personalization data.
